(19) United States
(12) Patent Application Publication
(10) Pub. No.: US 2008/0173515 A1
(43) Pub. Date: Jul. 24, 2008

(54) DISK SPRING HYDRAULIC RELEASE BRAKE

(75) Inventor: Richard Daigre, Hopkinsville, KY (US)

Correspondence Address: FAY SHARPE LLP, 1100 SUPERIOR AVENUE, SEVENTH FLOOR, CLEVELAND, OH, 44114, US

(73) Assignee: White Hydraulics, Inc., Hopkinsville, KY (US)

(21) Appl. No.: 11/971,734

(22) Filed: Jan. 9, 2008

Related U.S. Application Data
(63) Continuation of application No. 11/291,588, filed on Nov. 30, 2005.
Application No. 11/291,588 is a continuation of application No. 10/073,520, filed on Feb. 13, 2002, now abandoned.

(51) Int. Cl. F16D 67/04

(52) U.S. Cl. 192/18 A

(57) ABSTRACT

A selectively engageable friction mechanism such as a brake assembly including hard anodized brake disks having a single cross section and a bias assembly including a single spring, in the preferred embodiment such spring being a belleville spring

This application is a continuation of U.S. patent application Ser. No. 11/291,588, which is a continuation of U.S. patent application Ser. No. 10/073,520. Each of the two aforementioned patent applications are incorporated by reference herein in their entireties.

### BACKGROUND

This invention relates to a selectively engageable friction mechanism for a brake or clutch shaft such as those typically utilized in a combination axle support and brake mechanism.

### BRIEF DESCRIPTION

Selectively engageable friction devices for shafts have been utilized to control power in a positive mechanism (such as a motor clutch) and/or a negative mechanism (such as a brake). In some instances, the same shaft has been utilized for a secondary purpose, such as functioning as an axle (such as for a wheel) or a rotary support for a secondary member (such as a winch spool).

Certain of these friction devices include interleaved pairs of disks, each pair connected to differing parts thereof. Typically these mechanisms included concentric sintered rings of a friction substance on steel disks. This additional substance significantly increases the depth of each disk, as well as the overall length of any device incorporating these disks.

One application for brake shafts is as a combined axle and brake mechanism for scissorlifts. In addition to the above depth problems, the cost of the present combination mechanisms are high. Manufacturers of scissorlifts therefor commonly use live axles with separate drum brake mechanisms taken from a small automobile. These axle assemblies take hours of time to assemble and install. Others use a split steering axle in the back, with the brakes being either thereon or on the motor drive systems of the non-steerable front wheels.

Prior art brake and clutch assemblies often involve complicated manufacturing and assembly routines. An example is the multi-coil actuated brake disclosed in U.S. Pat. No. 6,145,635. Further the friction pads utilized therewith commonly require multi-step manufacturing techniques such as brazing of the metal or attachment of sintered metal rings. The brake bias mechanism can itself include multiple parts (e.g. numerous cylindrical coil actuation springs), again requiring complicated machining of the housing and assembly techniques. These involved manufacturing requirements greatly increase production and repair costs. In addition to initial assembly issues, the devices also effectively prevent repair of the mechanism in the field.

### SUMMARY OF THE INVENTION

It is an object of this invention to substantially simplify the manufacture and assembly of parts of a clutch/brake shaft and housing;

it is another object of this invention to reduce associated manufacturing and service costs;

It is a further object of this invention to extend the service life of the friction mechanism;

It is a further object of this invention to reduce the number of parts utilized in a service brake;

It is yet another object of this invention to facilitate the flexibility of brake assemblies;

It is still a further object of this invention to reduce the manufacturing tolerances for brake assemblies;

It is another object of this invention to provide for a brake assembly adaptable to multiple uses;

Other objects and a more complete understanding of the invention may be had by referring to the drawing in which:

### BRIEF DESCRIPTION OF THE DRAWINGS

FIG. 1 is a cross-sectional view of a series of brake disks incorporating the invention;

FIG. 2 is an enlarged view of an edge of a brake disk demonstrating the diffusion of the coating thereof;

FIG. 3 is a representational schematic of an engagement mechanism incorporating the invention;

FIG. 4 is a cross-sectional side view of a spring applied pressure released brake shaft built in accord with the invention in its spring applied condition;

FIG. 5 is a cross-sectional side view of the brake shaft of FIG. 4 with integral motor;

FIG. 6 is an end view of the disk spring utilized in FIG. 4;

FIG. 7 is a side view of the disk spring utilized in FIG. 4;

FIG. 8 is an end view of a brake disk used in FIG. 4;

FIG. 9 is a side view of the brake disk of FIG. 8;

FIG. 10 is an end view of reaction disk of FIG. 4;

FIG. 11 is a side view like FIG. 9 of the reaction disk of FIG. 10;

FIG. 12 is a cross-sectional view of a pressure applied spring release embodiment of the invention; and,

FIG. 13 is a view like FIG. 1 of a series of prior art disks.

### DETAILED DESCRIPTION

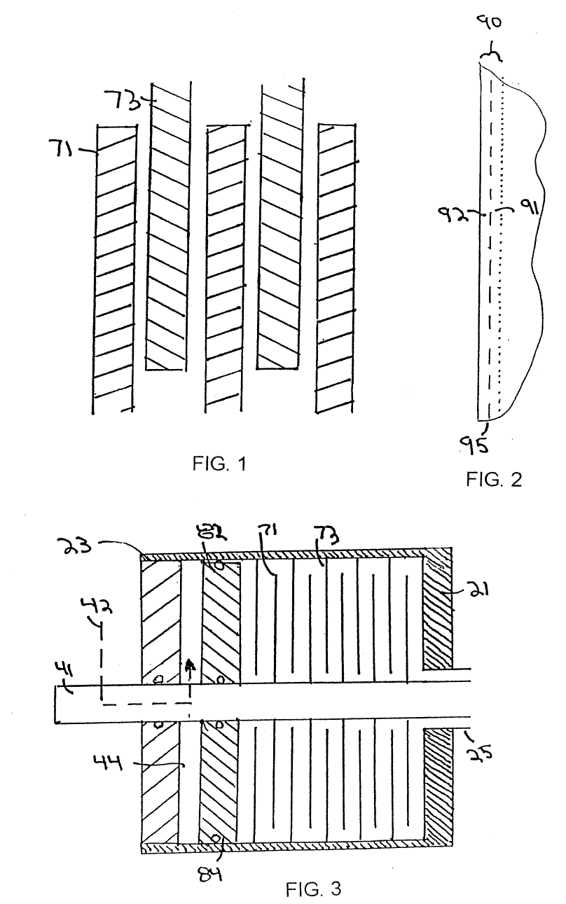

In this invention the engagement surfaces of disks in a disk pack is treated with a hardening agent to produce an integral wear surface (FIGS. 1-2). These disks are incorporated into an engagement mechanism (FIG. 3).

In the engagement mechanism at least a pair of disks 71, 73 are located adjacent to each other between an engagement mechanism 82 and a reaction surface 21. The two 81, 21 are movable in respect to each other so as to press the disks 71, 73 against each other. Since one disk 71 is drivingly connected to one part 41 while the other disk 73 is connected to another part 23, this action interconnects the two parts 41, 23 to each other. This serves as a clutch if both parts 41, 23 can rotate while serving as a brake if one part 41, 23 is relatively rotationally impeded. For example if part 23 is able to rotate at the same speed as part 41, the engagement action produces a driving connection therewith. This would result in power between 41 and 25. Additional example, if part 23 is fixed, engagement of the disks 71, 73 would retard rotation of part 41, thus producing a braking connection.

In the embodiment disclosed the engagement mechanism 82 is a piston 84 axially moved by fluid pressure through a sealed transfer passage 42 through part 41 into sealed cavity 44. With the utilization of a selective engagement as described between case, sun, planet carrier and/or planetary ring gears of a planetary mechanism, or differing gears in a multi-gear transmission, multi-speed functions can also be provided by this action, manually or automatically as desired by this mechanism. Many multi-speed gearing designs are known in the art.

In the invention of this application the surface of at least one disk 71, 73 is hardened so as to create an integral wear surface 90 (FIG. 2). This hardened wear surface 90 infuses into the physical metal 91 of the disk as well as building up 92 the thickness of the disk beyond its pre-hardened surface (dashed line 95 in FIG. 2). Preferably substantially half (30-60% preferred) of this hardening is internal of the pre-hardened surface. This reduces the possibility of flaking and separation while also allowing for efficient heat transfer as is possible in a single thickness disk.

In the embodiment of FIG. 2 the 6061-T6 aluminum disk has an original thickness of 0.083 with a hard anodized surface addition of 0.0025 “to its finished thickness (with a similar 0.0025 infusion into the basic disk material).”

Note that it is not necessary to harden both disks 71, 73. Indeed in the embodiment of FIG. 2 disk 73 is a steel disk covered with black oxide to 1-5 microns per side.

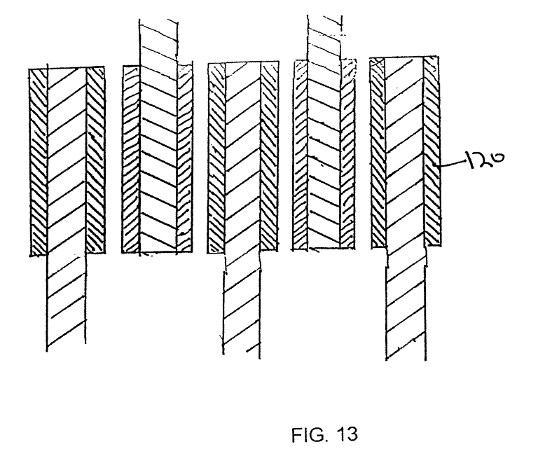

The inclusion of the invention produces a much shorter disk pack than otherwise possible (contrast the five disks of FIG. 1 with the five disks of FIG. 13—a device incorporating GEMPCO 473 friction material 120 on both steel disks building the thickness of each disk from 0.072 to 0.133 in the series shown. Note in both series of disks the disks are laterally spaced for clarity. In an actual device they would abut each other when engaged.). Even with the GEMPCO material on half the disks the difference is still significant. There is also a significant disparity in costs, with the GEMPCO disks requiring additional manufacturing operations and materials. Further the full overlapping area of the disks 71, 73 is utilized as a friction surface in the invention while the GEMPCO processed disks is limited to the extent of the GEMPCO.

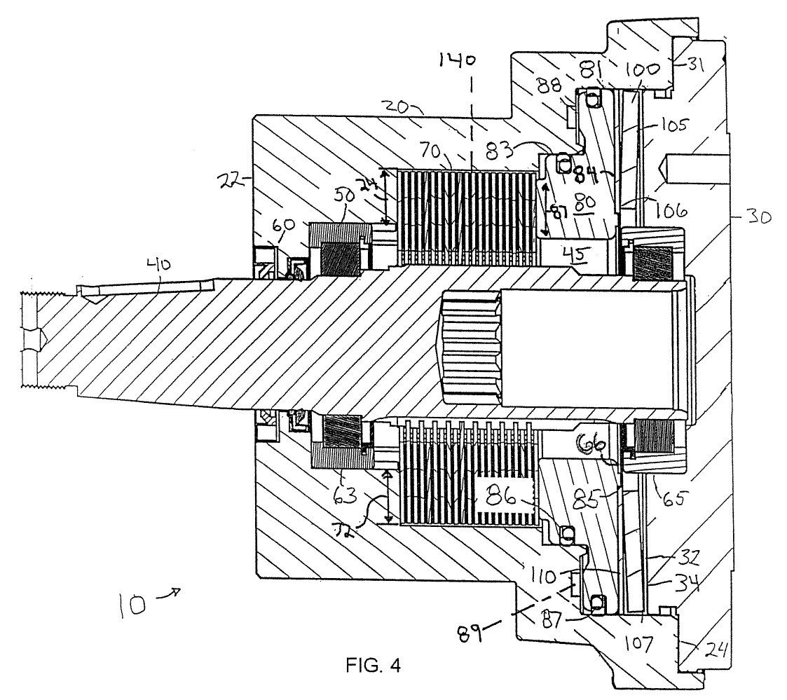

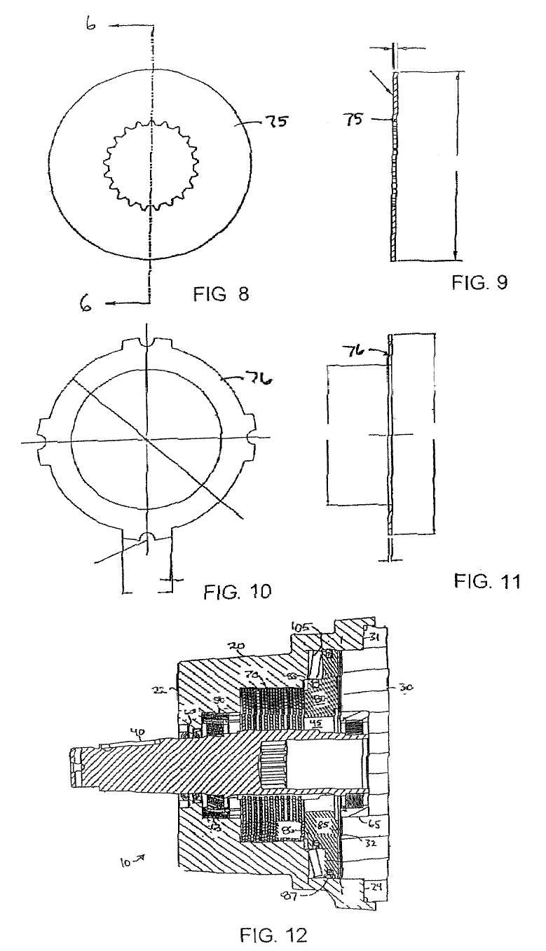

The preferred embodiment of this invention relates to a brake assembly 10 (FIGS. 4-12). The brake assembly 10 has a housing 20, a shaft 40, a brake mechanism 70 and a bias assembly 100.

The housing 20 serves to rotatively support the shaft 40 to a main structural member (not shown) as well as providing a location for the brake mechanism 70. The preferred housing 20 shown serves as the main axle support for a wheel, winch or other component attached to the shaft, physically transferring substantive forces to the structural member (such as the wheel to frame connection in a scissorlift). The particular housing disclosed is of two-part construction, having a front 22 and an endplate 30 with a cavity 45 between.

The front 22 of the housing 20 has substantially all the machined surfaces formed therein. In the embodiment shown these can be formed from one side thereof. This facilitates the alignment of the machined surfaces. This also reduces the cost of the brake assembly 10 as well as increasing service life. The major concentric surfaces which are machined in the front 22 of the housing shown include the areas surrounding the front bearing 50, the contaminant seal and the oil seals 60 and the two surfaces 81, 83 radially outward of the activating piston 80 for the brake mechanism 70.

The simplified design of the endplate 30 of the housing largely eliminates previously required machining. In the simplest embodiment, the endplate comprises a plate. Those areas which are machined in this preferred plate include the locations of the rear bearing 65 and the face surface 31 between the front 22 and the endplate 30. Note that it is further preferred that the distance between the face surface 31 and inner surface 34 of the plates be similar if not identical between individual end plates. This allows a manufacturer to factor this dimension out in the later described manufacturing procedure while at the same time providing for a uniformity of operation between such units. This in combination with the novel design of the bias assembly 100 further greatly simplifies manufacturing and assembly of the device (as later described).

The shaft 40 is rotatively supported to the housing 20 by bearings, a first bearing 63 in the housing front 22 and a second bearing 65 in the endplate 30. In the particular preferred embodiment disclosed bearings 63, 65 are roller bearings (FIG. 4). The inner race of the roller bearings 63, 65 shown are machined directly onto the shaft 40, thus allowing for a stronger bearing and smaller device for a given shaft diameter than possible with a bearing having its own separate inner race.

The oil seal is located directly next to the main bearing 63 in a seal cavity formed in the housing 20. The seal shown is a high pressure seal so as to contain the operative pressure utilized in moving the later described piston 80 in the cavity 45 against the biasing force of the spring 105 (this operating pressure is typically 1000-2000 PSI). An additional contaminant seal is located in a seal cavity formed in the housing 20 substantially next to the oil seal 60 axially outward thereof. This contaminant seal protects the oil seal and neighboring shaft from physical debris such as dirt and water.

The brake mechanism 70 preferably surrounds the shaft 40 located between the two bearings 63 and 65. This allows the bearings to primarily absorb any radial forces on the shaft 40 directly between such shaft to the housing 20. This separates the load bearing function of the shaft from the brake such that the brake mechanism 70 can be completely eliminated without compromising the physical and rotational support between the shaft 40 and housing 20.

The preferred embodiment of the brake assembly is spring activated and hydraulic pressure released (FIG. 4). If desired, an alternate activation mechanism could be utilized such as a pressure applied spring released brake, mechanical activation, and other systems. For example, in an alternate embodiment shown in FIG. 12, the bias assembly 100 may be located on the opposite side of piston 80 from the endplate 30, thus modifying the device to a pressure applied spring released brake. This alternate spring bias assembly thus biases the piston 80 away from the brake mechanism 70, allowing rotation of the shaft 40 in an unpressurized condition. (Note that in this embodiment the outer edge of the spring is in contact with the endplate 30.)

In the preferred spring applied pressure released embodiment described herein, the bias assembly 100 biases the piston 80 against the brake mechanism 70 to prevent rotation of the shaft 40 in its unpressurized default unactivated condition.

In this preferred spring applied pressure released embodiment disclosed, the bias assembly 100 is located radially outwards of bearing 65. This produces a shorter axial length device than if the bias assembly were to be axially displaced from the bearing 65. Note that in the preferred embodiment the outer race 66 of the bearing 65 also functions as a limit stop for the piston 80 (due to the physical contact of the inner edge 85 of the piston 80 therewith). This limit stop prevents the compression of the disk spring 105 beyond its designed limits. This use of the bearing race as a limit stop also reduces the number of separate parts in the device, simplifying its construction.

The bias assembly 100 shown consists of a single spring 105 located substantially between the piston 80 and the endplate 30. The spring 105 provides uniform biasing over the entire contact surface of the piston 80 through axial compression of the surface of the spring. In the most preferred embodiment, the spring 105 is a disk spring.

This disk spring 105 replaces the multiple actuation coil springs of prior art devices, thus substantially simplifying and reducing the cost of manufacturing, assembly and repair of the brake assembly 10. Such spring 105 also provides substantial spring pressure in a reduced axial length, allowing for a more compact device. The spring 105 develops its force due to the loading of its inner circumferential edge 106 relative to its outer circumferential edge 107, the former in contact with the piston 80 (through washers later described) and latter in contact with the endplate 30. This develops a spring force through a working range from a first load point (the spring 105 compressed against the endplate by the piston 80 due to the pressurization of cavity 88 through a port 89 removing the spring force from the braking mechanism 70) to a second load point (the piston 80 transferring the force from the spring 105 to the brake mechanism 70). In the preferred embodiment of FIG. 1 this provides for an unbraked and braked condition respectively.

The disk spring 105 develops a high spring force with a relatively small deflection in a short length of device. Further, the spring accomplishes this within a limited area while at the same time providing a significant number of cycles within its working range. Note that it is preferred that the inner edge 106 of the spring 100 be substantially aligned within the radial confines 72 of the brake mechanism 70. The radial confines are defined by the overlapping radial areas 24, 87 respectively between the brake mechanism 70 to the front 22 of the housing 20 at one end and brake mechanism 70 to the piston 80 at the other end. This provides for the efficient transfer of application forces axially through the brake mechanism 70.

In the preferred embodiment disclosed, the disk spring 105 is 6 inches in total diameter with an inner diameter of 3.25 inches. The disk spring has an initial height of approximately 0.38 inches and a thickness of approximately 0.19 inches. It has a Youngs modulus of approximately 30,000 KSI with a Poisson ratio of 0.3. It develops a spring force of approximately 5,000 pounds at 0.09 inches deflection to 6,100 pounds at 0.13 inches deflection (with a compressed height of 0.29 to 0.25 respectively). It is cycled up to three times 0.04″ prior to measurements. It has a 1 million cycle life span between load points. The material is a standard cold formed carbon steel. It is manufactured to the group 1, 2 or 3D in standard 2092/2093 the contents of which are included by reference. (Note that while in the particular embodiment, there is no slotting, such could be included as could rounding of the edges and/or flattening of the load bearing surfaces 106, 107).

In the embodiment disclosed, there is a washer 110 located between the spring 105 and at least one of the piston 80 or the endplate 30. The outer diameter of edge 107 of this washer substantially matches that of the surface 81 while the inner diameter of edge 106 is located between such surface spaced from outer circumference of the bearing 65 (in the embodiment disclosed 5.7 inches).

Washer 110 facilitates the application of forces through the piston 80 from the spring 105 to the brake disks. This provides for a uniformity of forces for an individual brake through the service life thereof, as well as providing for a uniformity between differing brakes.

In respect to the uniformity forces for an individual unit, each brake is designed for a given braking force (resistance to rotation of the shaft 40 to the housing 20). This force is due to the transfer of spring force from the spring 100 through the piston 80 to the brake mechanism 70. With a knowledge of the distance between the inner surface 34 of the endplate 30 and the adjoining surface 84 of the piston 80 (with the brake mechanism 70 is a compressed state) and the depth of the spring 105 (in its brake actuating position extended position) the depth of the washer 110 for and individual unit can be calculated by the difference. This allows an individual brake unit to be designed for a specific level of braking performance. Further the unit will maintain this performance over time.

In respect to the uniformity between differing brakes, since each individual unit 10 has its own compensating washer 110 and is set for a certain braking force from the spring 105, units across a series can be set to the same braking force (if desired). This allows for a manufacturer to maintain braking forces uniformly, allowing individual units to be exchanged without compromise to performance. This also provides for the use of parts (other than the compensating washer) across a series of brakes, facilitating the construction and maintenance of the brakes.

Note that in addition in the absence of such washer 110 the edge(s) of the spring 105 might over time abrade against the piston 80 or the endplate 30. This could effect performance uniformity over time. It could also create grooves over time which would reduce the efficiency and longevity of the brake assembly 70.

The actual depth of this washer 110 is developed during the assembly of each individual device. The reason for this is that while the individual disk springs 105 are manufactured repeatedly in high quantities with close tolerances, the dimensions of the brake mechanism 70 and the piston 80 (together with the relative thickness of the endplate 30 from the surface 31 to the surface 32) may provide stacking tolerances which provide for an uneven application of force in individual units over a production run of brakes incorporating the invention. To accommodate for this the brake mechanism 10 is assembled including its brake mechanism 70 and its piston 80. At this time the piston 80 is loaded by a press to its design application force, in the present example 5,000 pounds. At this time the distance between the outer surface 84 of the piston and the inner surface 24 of the housing 20 (and thus inferentially the plane 32 of the endplate since the piston 80 and end plate 30 is of a known depth) is measured. Given the known geometry of the washer 105 this measurement provides the combined desired thickness of the washer 110. The load is then removed and the washer 110 is selected to precisely compensate for the unique geometry of this particular unit. At this time the spring disk 105 is inserted and the endplate attached to the housing 20 to complete the brake mechanism. This design provides for a brake mechanism 10 that has a spring 105 which can be used interchangeably with any brake mechanism, with the washer 110 ensuring a fit and uniform consistent operation irregardless of the individual components utilized in this particular brake.

The washer 110 is located between the spring 105 and the piston 80 performs two functions: to allow compensation for the tolerances within the brake mechanism as well as to provide a unique solution for preventing the wear of the piston 80 by the spring 105. In the absence of the washer 110 the edge of the spring 107 may bind against the piston 80 creating small grooves that would reduce the efficient longevity of the brake assembly. In the presence of such washers, no such binding occurs, allowing for the bias assembly 100 to inface with the piston 80 without hindrance.

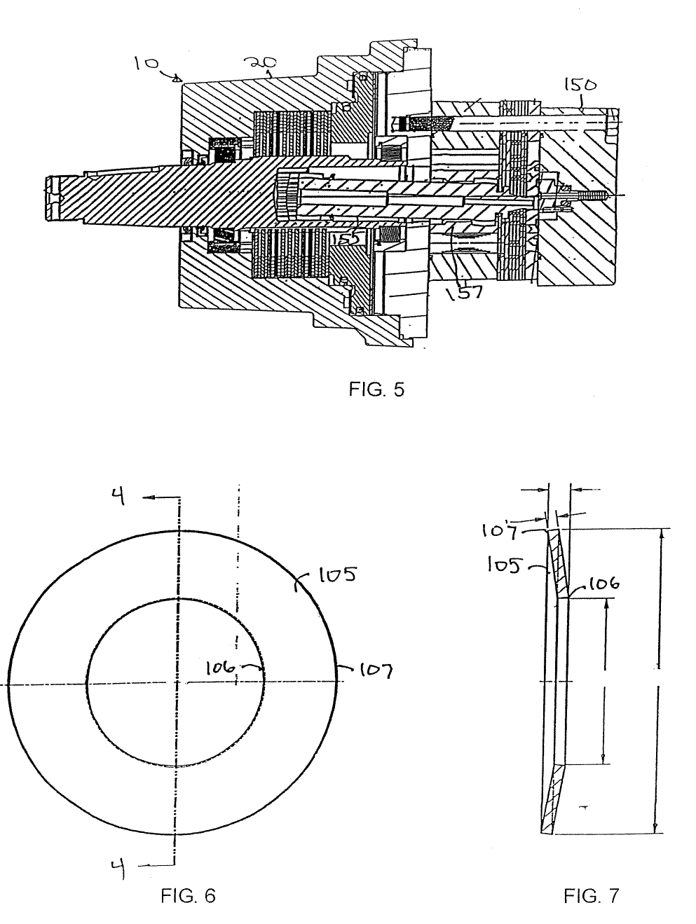

Note that in the event that the device is used as a combined motor brake mechanism (such as in FIG. 5), it is preferred that the brake mechanism 10 be assembled in its entirety with a certain endplate, with the brake mechanism then shipped in its assembled condition to a separate assembly line for conversion. The preferred conversion technique removes the endplate 30, machines it to accommodate the motor, and then reassembles the unit to provide for an integrated motor/brake mechanism. This reduces unit to unit deviances while also recognizing the fact that a combined motor/brake would have a lower production volume than a brake alone.

The rotation of the shaft 40 in the preferred embodiment is selectively prevented by the force of the spring disk 105 on the piston 80, which in turn contacts the brake mechanism comprising a set of brake disks 75, 76. These disks 75, 76 are interleaved alternating disks interconnected to the shaft 40 or the housing 20, respectively.

The friction disks 75 are non-rotatively connected to the shaft 40.

In a present design friction disk, the brake disk is steel with GEMPCO 473 friction material lining on its inner and outer sides, each lining being approximately 0.03 inches thick. This sintered bronze lining material is expensive and in addition complicates the manufacturing and assembly process of the device.

In the brake disk of the present invention, the friction disks are made of a single thickness material having a hard surface. In the preferred embodiment this hard surface is provided by having the material hard anodized. The hard surface could alternately be providing by a coating, such as a hardening material. This provides for a very hard brake disk having a relative single thickness throughout. In the preferred embodiment such friction disks 75 are constructed of hard anodized metal, most preferably aluminum. Such treatment provides high hardness and wear resistance (comparable to that of steel), shock resistance and strength as well as high flexibility and fatigue strength. This reduces the manufacturing cost of the friction disks 75 by an order of magnitude without sacrificing performance or longevity of the brake mechanism 70.

In the preferred embodiment disclosed, the disks are 4.0 inches in diameter and 0.082 inches thick and is constructed of T6 aluminum anodic hard anodized coating to Mil-Spec Mil-A-8625 type III class 1 or equivalent spec to a thickness on each side of 0.002±0.001 with the majority of saturation of 0.001. The contents of this Mil-Spec is incorporated by reference. The inner edge is grooved to match outer ridges on the shaft 40 thereby to connect to same for common rotation. The specific coating employed by the preferred alternate coating embodiment described is Keronite registered by Isle Coat Ltd., UK. This coating is a complex oxide ceramic produced by surface oxidation electrolysis on the aluminum.

Interleaved with the friction disks 75 are a series of reaction disks 76. By interleaved, it is intended that the friction and reaction disks alternatingly overlap (FIG. 1). The reaction disks 76 are interconnected with the housing 20 in a non-rotative manner. The number of reaction disks is preferably substantially the same as the number of friction disks. One different or multiple non-adjoining series (ABBABBA, ABBAABA, etc.) could also be utilized if appropriate or desired for a given application. Since any rotation of the reaction disks 76 in respect to the housing 20 would allow for some lash, it is preferred that the reaction disks 76 are supported solidly to the housing. Methods of connection employed may include but are not limited to pins, tabs and grooves, etc.

The particular reaction disk 76 is 4 inches in diameter with a series of 4 mounting tabs extending to a 4.3 inch diameter therefrom at approximately 900 intervals. It has an inner diameter of 3 inches and a black oxide coating 1-5 microns per side.

Upon selective interconnection of a port 89 to a source of high pressure, preferably via a valve of some nature, cavity 88 is pressurized, thus overcoming the force of the bias assembly 100 so as to release the brake (in FIG. 4) or applying it (as in FIG. 12). Two seals, 86, 87 located between the piston 80 and the housing 20 retain the pressure in the activation cavity, thus allowing for the activation of the piston 80.

The particular brake mechanism 70 disclosed in this application is a “wet” brake. By this it is meant that the cavity 25 containing the brake mechanism contains hydraulic fluid, albeit substantially unpressurized. This cools the brake mechanism in addition to facilitating the removal of the residue of the friction material which is inevitable in any braking operation. In the preferred embodiment, the oil seal 60 is located in the housing 20 in sealing contact with shaft 40 to prevent loss of lubricant.

Preferably, there is a connection 140 provided to an overflow mechanism to allow for breathing of the fluid in the cavity in addition to allowing for the release of any pressurized fluid which might leak from the cavity 88 into the center 45 of the device surrounding the shaft and brake mechanism 70. This interconnection also allows for the fluid fluctuation which is inherent in the device upon the movement of the piston 80 in the routine operation of the device.

The interconnection between the cavity 88 and the overflow mechanism is not critical. This may be provided by a hole 140 surrounding the brake disks, a hole in the endplate 30, or other appropriate mechanism.

In an alternate embodiment, the shaft 40 may be splined and connected to a drive mechanism 150 (FIG. 5). Examples include a unit wherein the inside opening in the drive shaft 40 would be splined and the endplate 30 replaced by hydraulic power unit 150, an electric motor, or other power unit connected to such splines. It is preferred that such drive mechanism be hydraulic in nature, such as the White Hydraulics, Inc. models RS, RE or DT, TRW M series, Eaton, or Parker Hannifin motors.

In a few of such embodiments, the wobble stick 155 is connected to the shaft 40 and the orbiting rotor 157. Such wobble stick 155 compensates for the relative displacement between the axis of shaft 40 and the axis of the orbiting rotor 157. Note in the preferred embodiment the pressure of the gerotor mechanism 150 is isolated from that of the brake 10 (by the closed center construction of the motor such as that in U.S. Pat. No. 4,877,383, Device having Sealed Control Opening, U.S. Pat. No. 5,135,369, Seal Piston, U.S. Pat. No. 6,257,853 B1, Hydraulic Motor, U.S. Pat. No. 6,074,188, Multi-Plate Hydraulic Motor Valve, the contents of which are incorporated by reference). This is preferred so as to fluidically isolate the two. A combined design could also be utilized such as that in U.S. Pat. No. 3,452,680, Hydraulic Motor Pump Assembly, the contents of which are incorporated by reference. (Operation of open center hydraulic motors would result in pressurization of the inner chambers of the brake assembly 10, including the cavity 45 containing brake mechanism 70. Such pressurized embodiment open center embodiment would require oil seal 60 to be selected as a high pressure seal).

Cavity 88 could be internally-and or externally connected to the one port of the hydraulic motor 150 to allow selective pressurization of the cavity 88. (Directly or through a separate valve note that no valves are necessary between the cavity 88 and the port of the hydraulic motor 150.) Due to this optional interconnection, activation of the motor 150 in this specific embodiment would necessarily pressurize cavity 88, move piston 80, and release the brake (note such embodiment, however, is not preferred as wear of brake disks 75, 76 creates contaminants).

Although the invention has been described in its preferred forms with a certain degree of particularity, it is to be understood that changes can be made deviating from the invention as hereinafter claimed. For example, although the device disclosed utilizes anodized aluminum friction disks 75, it would be possible to combine these with conventional components so as to provide for a good measure of the included invention. Additional example the materials of the friction disks could be utilized in the reaction disks (in exchange or in addition). Another example, two or more washers could be utilized in order to eliminate potential interaction between the rotatively and axially moving components of the brake mechanism and that of the axially moving piston 80 and spring 105 if desired. For additional example, although the preferred embodiment described herein is characterized as a brake mechanism, the involved technology is also applicable to other selectively engageably friction devices, such as clutches. Other modifications can also be made without deviating from the invention as hereinafter claimed. It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A wet brake/clutch assembly comprising:
a shaft;
a plurality of friction disks mounted to the shaft for rotation with the shaft, each friction disk extending in a radial direction from a rotational axis of the shaft, each friction disk comprising aluminum having an anodized wear surface;
a housing receiving the shaft;
a plurality of reaction disks mounted to the housing extending substantially perpendicular to the rotational axis of the shaft, the reaction disks being interleaved between the friction disks;
a piston disposed in the housing, the piston being moveable between an engaged position and a disengaged position, the engaged position being where the piston is moved towards a friction disk or reaction disk to press the friction disks against the reaction disks and the disengaged position being where the piston is moved away from a friction disk or reaction disk to allow for rotation of the friction disks with respect to the reaction disks; and
a first seal contacting the shaft and the housing and a second seal contacting the piston and the housing, a cavity being defined in the housing between the first seal and the second seal, the friction disks and the reaction disks being disposed in the cavity and the seals being configured to confine hydraulic fluid in the cavity.

2. The assembly of claim 1, wherein the friction disks each have a thickness measured generally parallel to the rotational axis of the shaft, the thickness being substantially constant throughout the disk including the anodized wear surface.

3. The assembly of claim 1, wherein the reaction disks are made of steel.

4. The assembly of claim 1, further comprising an overflow opening through the housing and in communication with the cavity to allow for the release of pressurized fluid from the cavity.

5. The assembly of claim 1, wherein the cavity is not pressurized.

6. The assembly of claim 1, further comprising a third seal contacting the piston and the housing, the third seal being axially spaced from the second seal, a chamber being defined in the housing between the second seal and the third seal.

7. The assembly of claim 6, wherein the housing includes a port in communication with the chamber and an associated hydraulic fluid source, hydraulic fluid being introduced into the chamber to selectively move the piston.

8. The assembly of claim 7, wherein the housing includes a relief passage in communication with the cavity for releasing fluid that leaks from the chamber into the cavity.

9. A hydraulically actuated brake/clutch assembly comprising:
a shaft;
a plurality of friction disks mounted to the shaft for rotation with the shaft, each friction disk extending in a radial direction from a rotational axis of the shaft, each friction disk comprising aluminum and having a thickness measured generally parallel to the rotational axis of the shaft being generally uniform from an outer radial edge of the disk to an inner radial edge of the disk, wherein each friction disk includes a hardened anodized surface infused into the aluminum of each disk;
a housing receiving the shaft;
a plurality of reaction disks mounted to the housing extending substantially perpendicular to the rotational axis of the shaft, the reaction disks being interleaved between the friction disks;
a piston disposed in the housing, the piston being moveable between an engaged position and a disengaged position, the engaged position being where the piston is moved towards a friction disk or reaction disk to press the friction disks against the reaction disks and the disengaged position being where the piston is moved away from a friction disk or reaction disk to allow for rotation of the friction disks with respect to the reaction disks;
a biasing member contacting the piston; and
a first seal contacting the shaft and the housing and a second seal contacting the piston and the housing, a cavity being defined in the housing between the first seal and the second seal, the friction disks and the reaction disks being disposed in the cavity and the seals being configured to confine hydraulic fluid in the cavity for cooling the friction disks and the reaction disks.

10. The assembly of claim 9, wherein each reaction disk comprises a steel disk.

11. The assembly of claim 9, wherein the hardened anodized surface of each friction disk builds up a dimension of the disk measured parallel to the rotational axis of the shaft.

12. The assembly of claim 9, wherein each reaction disk comprises a steel disk covered with black oxide.

13. The assembly of claim 9, wherein the housing includes a relief passage in communication with the cavity for releasing pressurized fluid in the cavity.

14. The assembly of claim 9, wherein the shaft includes a plurality of ridges running generally parallel to the rotational axis of the shaft, and wherein each friction disk includes a plurality of grooves that receive the ridges to mate the disks to the shaft.

15. The assembly of claim 9, wherein each friction disk includes a hardened anodized surface extending from a radial outer edge of the disk to a radial inner edge of the disk.

16. The assembly of claim 9, wherein the hardened anodized surface includes a smaller wear surface for the friction disk that selectively contacts a wear surface of the reaction disk, wherein the wear surface for the friction disk has a constant thickness measured parallel to the rotational axis of the shaft that is generally equal to a thickness of a remainder of the friction disk.

17. A wet brake/clutch assembly comprising:
a shaft;
a housing receiving the shaft and defining a cavity for containing cooling fluid;
at least two disks disposed in the cavity containing the cooling fluid, a first of the disks mounted to the shaft for rotation with the shaft and extending in a radial direction from a rotational axis of the shaft, a second of the disks mounted to the housing extending substantially perpendicular to the rotational axis of the shaft, at least one of the disks comprising aluminum having an anodized wear surface; and
a piston disposed in the housing, the piston being moveable between an engaged position and a disengaged position, the engaged position being where the piston is moved towards the disks to press the first disk against the second disk and the disengaged position being where the piston is moved away from the disks to allow for rotation of the first disk with respect to the second disk.

18. The assembly of claim 17, wherein at least one of the disks has a thickness measured generally parallel to the rotational axis of the shaft, the thickness being substantially constant throughout the disk including the anodized wear surface.

19. The assembly of claim 17, further comprising an overflow opening through the housing and in communication with the cavity to allow for the release of pressurized fluid from the cavity.

20. The assembly of claim 17, wherein the cavity is not pressurized.
